(19) United States
(12) Patent Application Publication
(10) Pub. No.: US 2006/0260201 A1
(43) Pub. Date: Nov. 23, 2006

(54) Cover strip

(75) Inventor: Gerhard Fischer, Deizisau (DE)

Correspondence Address: WARN, HOFFMANN, MILLER & LALONE, .P.C, PO BOX 70098, ROCHESTER HILLS, MI, 48307, US

(73) Assignee: Decoma (Germany) GmbH, Sulzbach (DE)

(21) Appl. No.: 11/430,546

(22) Filed: May 9, 2006

(30) Foreign Application Priority Data
May 9, 2005 (DE) 102005022582.9

(51) Int. Cl. B60J 1/16

(52) U.S. Cl. 49/377

(57) ABSTRACT

A cover strip and a sealing arrangement are described. The cover strip described serves to cover a window shaft in a motor vehicle and comprises a cover part and a carrier part. Furthermore, the cover strip is designed to surround a plastics insert of a sealing arrangement at least partially, and is made in one piece.

### CROSS-REFERENCE TO RELATED APPLICATIONS

This application claims priority to German Patent Application No. 10 2005 022 582.9 filed on May 9, 2005.

### TECHNICAL FIELD

The invention relates to a cover strip for covering a window shaft in a motor vehicle and a sealing arrangement for sealing a window shaft in a motor vehicle.

### BACKGROUND TO THE INVENTION

In motor vehicles, the side windows in particular have window shafts in which the window panes which can be moved up and down are guided in one plane. To prevent moisture and dirt from getting into these window shafts sealing arrangements are generally provided between the window and the door panel to prevent this, so that the operation of the movable windows is ensured in the long term.

Moreover, it is common for protective cover strips or cover strips to be mounted in the region of the sealing arrangements, with the intention of improving the visual impression of the transition between the door panel and the window and optionally also providing additional protection from external influences.

German Patent DE 696 08 444 T2 discloses a sealing arrangement for sealing against a generally flat surface which is movable along a predetermined pathway. This movable surface may for example be a window guided in a window shaft. The sealing arrangement described comprises assembly means for fixing the sealing arrangement and sealing means which are resiliently supported by the mounting means and comprise a flexible material which bounds a longitudinally extending hollow chamber. The specification particularly describes a waisted seal which has a clamping region formed from plastics or rubber material and extruded over an embedded channel-shaped metal carrier, this clamping region consisting of a plastics insert.

Multi-part cover strips are also known which are made in several pieces from a metallic cover part and a plastics carrier part. These require an additional metallic element for fixing or clamping the plastics insert.

### SUMMARY OF THE INVENTION

The cover strip for covering a window shaft in a motor vehicle according to the invention has a carrier part and a cover part. The cover part constitutes the part of the cover strip which is visible from outside and thus gives the visual impression of the cover strip and of the transitional area between the door panel and window.

The carrier part is normally on the inside and serves to fix or clamp a plastics insert of a sealing arrangement, which is at least partly surrounded by the cover strip.

The cover strip according to the invention is further characterized in that it is made in one piece. The cover strip, which is typically formed in one piece or uniformly from one material ensures adequate fixing of the plastics insert which is at least partly surrounded by the cover strip; once surrounded and clamped by the one part cover strip this plastics insert is also referred to as the clamping region. The cover strip according to the invention thus takes on mechanical functions and ensures the stability of the plastics insert or of the clamping region. There is no need for any additional plastics carrier part.

The cover strip according to the invention is preferably made from a metallic material, e.g. aluminium or chrome steel.

Typically, a sealing lip is provided on the cover strip, and abuts on the movable window in the installed position. Preferably, the sealing lip is adhesively bonded to the cover strip, optionally using double-sided adhesive tape.

The sealing lip usually consists of a rubber material which ensures a tight and sealing contact with the movable window.

The cover strip may be constructed so as to latch in place. In another embodiment, an additional fixing device is provided, which may consist of an expansion clip. In any case, the cover strip is securely held and surrounds at least part of the plastics insert that forms the clamping region.

The sealing arrangement, according to the invention, serves to seal off the window shaft of a motor vehicle and has a cover strip as hereinbefore described which at least partially surrounds a plastics insert, and a sealing lip which is mounted on the cover strip.

The sealing arrangement according to the invention preferably also has a knurled flange.

The sealing lip optionally comprises a visible lip profile and a functional lip profile. Thereby, the sealing lip profile provides the visual impression whereas the functional lip profile predominantly performs the sealing function.

In a preferred embodiment, the sealing lip is made of a rubber material. This sealing lip may for example be attached to the cover strip by means of a double-sided adhesive tape. The cover strip is preferably made of a metallic material such as aluminium or chrome steel.

Further features and advantages of the invention will become apparent from the description and the accompanying drawings.

It should be realised that the features described above and those to be explained hereinafter may be used not only in the particular combination specified but also in other combinations or on their own without departing from the scope of the present invention.

### BRIEF DESCRIPTION OF THE INVENTION

The invention is schematically shown in the drawings by means of exemplary embodiments and is hereinafter described in detail with reference to the drawings.

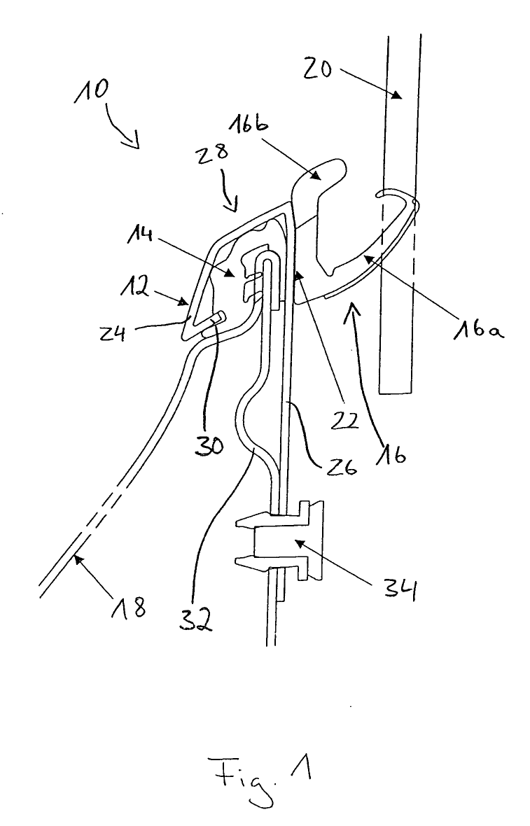

FIG. 1, shows a preferred embodiment of the sealing apparatus according to the invention having a cover strip according to the invention.

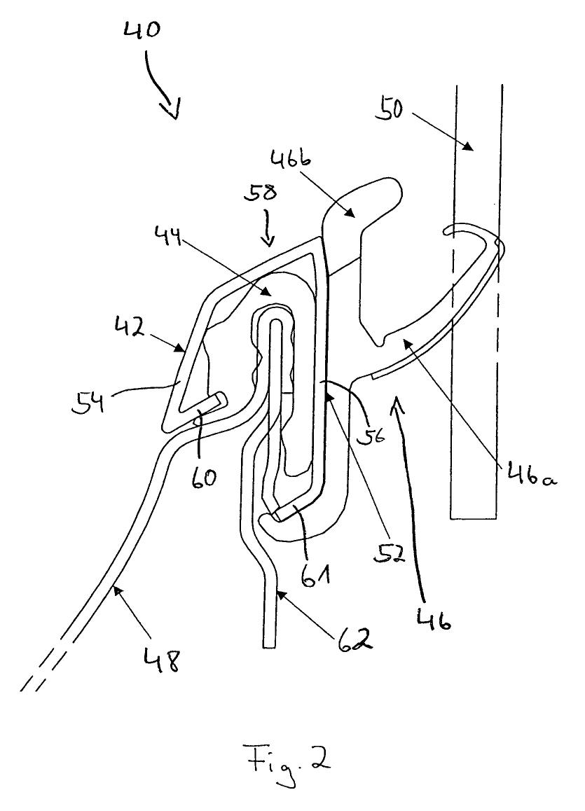

FIG. 2, shows another preferred embodiment of the sealing arrangement according to the invention.

### DETAILED DESCRIPTION OF THE PREFERRED EMBODIMENTS

FIG. 1 shows a preferred embodiment of the sealing arrangement according to the invention, generally designated 10. The diagram shows a cover strip 12, a plastics insert 14, a sealing lip 16, a door panel 18 and a window 20.

The sealing arrangement 10 with the cover strip 12, the plastics insert 14 and the sealing lip 16 is arranged between the door panel 18 and the window 20 such that the gap between the door panel 18 and the window 20 is sealed.

The sealing lip 16 is attached to the cover strip 12 by means of a double-sided adhesive tape 22 and comprises a functional lip profile 16a and a visible lip profile 16b. The visible lip profile 16b can be seen from outside. The functional lip profile 16a abuts directly on the window 20.

The cover strip 12 comprises a cover part 24 and a carrier part 26, joined together by a region 28 comprising multiple bends or creases. Thus, the cover strip 12 defines a space or partially surrounds the space in which the plastics insert 14 is held. One end 30 of the cover strip 12 engages in the plastics insert 14. The cover strip 12 is shaped so as to surround the plastics insert 14 at least in the upper region and fixes and clamps this plastic insert 14, which is also referred to as the clamping region. The carrier part 26 ensures that the cover strip 12 is held firmly in place.

A knurled flange 32 is also provided which is fixed to the carrier part 26 by means of an expansion clip 34, which serves as an anti-theft device. This expansion clip 34 mechanically secures the cover strip 12 in position.

FIG. 2 shows another embodiment of the sealing arrangement according to the invention which in this case is designated 40. It also comprises a cover strip 42, a plastics insert 44, a sealing lip 46, a door panel 48 and a window 50.

In this embodiment, too, the sealing lip 46, which comprises a functional lip profile 46a and a visible lip profile 46b, is attached to the cover strip 42 by a double-sided adhesive tape 52.

The cover strip 42 comprises a cover part 54, a carrier part 56 and a region 58 which connects these two parts and is made in one piece from one material. A first end 60 of the cover strip 42 engages in the plastics arrangement 44. A second end 61 of the cover strip 42 is curved so that the cover strip 42 can latch to a knurled flange 62, thus doing away with the need for any additional fixing element.

In this embodiment, too, the particular construction of the cover strip 42 provided accommodates the plastics insert 44, which is securely held and can be secured by the one-piece cover strip 42, thereby ensuring that the cover strip 42 is safely held in position in durable manner.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. Cover strip for covering a window shaft in a motor vehicle, which comprises a carrier part and a cover part, the cover strip being shaped so as to surround a plastics insert of a sealing arrangement at least partially, and is constructed in one piece.

2. Cover strip according to claim 1, which is made of a metallic material.

3. Cover strip according to claim 2, which is made of aluminium.

4. Cover strip according to claim 2, which is made of chrome steel.

5. Cover strip according to claim 1, further comprising a sealing lip mounted thereon.

6. Cover strip according to claim 5, wherein the sealing lip is attached by adhesive.

7. Cover strip according to claim 6, wherein the sealing lip is attached by means of double-sided adhesive tape.

8. Cover strip according to claim 5, wherein the sealing lip comprises a rubber material.

9. Cover strip according to claim 1, which is constructed so as to latch in position.

10. Cover strip according to claim 1, further comprising an additional fixing device is provided.

11. Cover strip according to claim 10, wherein an expansion clip serves as the fixing device.

12. Sealing arrangement for sealing a window shaft in a motor vehicle, comprising a cover strip including a carrier part and a cover part which at least partially surrounds a plastics insert, and a sealing lip which is mounted on the cover strip, said cover strip being made in one piece.

13. Sealing arrangement according to claim 12, which additionally comprises a knurled flange.

14. Sealing arrangement according to claim 12, wherein the sealing lip comprises a visible lip profile and a functional lip profile.

15. Sealing arrangement according to claim 12, wherein the sealing lip is made of a rubber material.
